(19) United States
(12) Patent Application Publication
(10) Pub. No.: US 2021/0063221 A1
(43) Pub. Date: Mar. 4, 2021

(54) CONDITIONING DEVICE FOR REGULATING A GASEOUS OR LIQUID FLUID AT A CONSTANT TARGET TEMPERATURE

(71) Applicant: AVL LIST GMBH, GRAZ (AT)

(72) Inventors: MARKO REIBENSCHUH, MIKLAVZ Na D.p. (SI); ALEXANDER VOLK, KAINBACH BEI GRAZ (AT); PATRICK TINAUER, GRAZ (AT); VEDRAN BURAZER, GRAZ (AT); ANDRE STEINHOEFLER, HARTBERG (AT)

(73) Assignee: AVL LIST GMBH, GRAZ (AT)

(21) Appl. No.: 17/040,556

(22) PCT Filed: Mar. 27, 2019
(86) PCT No.: PCT/AT2019/060107

§ 371 Date: Sep. 23, 2020

(30) Foreign Application Priority Data
Mar. 28, 2018 (AT) A 50265/2018

(51) Int. Cl. G01F 15/02; G01M 15/04; G05D 23/19

(52) U.S. Cl. CPC G01F 15/022; G05D 23/1919; G01M 15/048

(57) ABSTRACT

A conditioning device for regulating a gaseous or a liquid fluid to a constant target temperature includes an inlet fluidically connected to a supply system, an outlet fluidically connected to a consumer, a first fluid line arranged between the inlet and outlet, a heater arranged in the first fluid line, a second fluid line arranged to branch off from the first fluid line upstream of the heater and to open out into the first fluid line downstream of the heater, a regulating valve which regulates a fluid flow arranged either in the first fluid line or in the second fluid line, a temperature sensor arranged in the first fluid line downstream of where the second fluid line opens out into the first fluid line, and a check valve arranged either in the first fluid line or in the second fluid line in which the regulating valve is not arranged.

### CROSS REFERENCE TO PRIOR APPLICATIONS

This application is a U.S. National Phase application under 35 U.S.C. § 371 of International Application No. PCT/AT2019/060107, filed on Mar. 27, 2019 and which claims benefit to Austrian Patent Application No. A 50265/2018, filed on Mar. 28, 2018. The International Application was published in German on Oct. 3, 2019 as WO 2019/183658 A1 under PCT Article 21(2).

### FIELD

The present invention relates to a conditioning device for regulating a gaseous or liquid fluid to a constant target temperature, the conditioning device having an inlet which is adapted to be fluidically connected to a supply system and an outlet which is adapted to be fluidically connected to a consumer, a first fluid line between the inlet and the outlet, a heater arranged in the first fluid line, a second fluid line branching off the first fluid line upstream of the heater and running into the first fluid line again downstream of the heater, a regulating valve via which the fluid flow is adapted to be regulated and which is arranged in one of the two fluid lines, and a first temperature sensor arranged in the first fluid line downstream of the place where the second fluid line opens out into the first fluid line.

### BACKGROUND

Such conditioning devices are in particular required for fluid consumption measurement, namely, for both mobile and stationary fluid consumption measurement, as well as for liquid fluids, such as gasoline, ethanol, methanol or diesel, and for gaseous fluids, such as hydrogen, air or gas. The conditioning of fluids serves to improve the accuracy of the consumption measurement which would otherwise be affected by volume flow changes due to temperature variations which in particular occur during intermittent/nonsteady operation of the internal combustion engine.

For obtaining as constant a temperature of the fluid as possible both directly and indirectly, operating conditioning devices have previously been described wherein the indirectly operating conditioning devices regulate a heat flow or a cooling flow in the respective heaters or coolers of the conditioning device, while in the directly operating conditioning device, the temperature of the fluid is regulated by adjusting corresponding mixing ratios of a heated fluid and a non-heated or cooled fluid to corresponding ratios. The direct conditioning here has a considerably larger dynamic. An indirectly operating conditioning device can be a so-called heating bath, for example, an oil bath, wherein the oil is heated and a fuel line is indirectly heated by the hot oil. In contrast thereto, in the case of direct heating or cooling, the heating element is directly arranged in a fuel line. Concepts have also previously been described where the direct and the indirect type of heating or cooling are additionally combined.

DE 10 2006 036 667 A1 describes a conditioning device where a cooler, a heater and a delivery pump are connected in series in the delivery line. Depending on the desired temperature, the fluid is thus either heated or cooled for obtaining the target temperature. For temperature regulation, the fed heat amount or the fed cooling amount must here be regulated so as to be an indirect conditioning. A cooler is additionally provided in the return line of the internal combustion engine in order to nevertheless provide sufficient dynamics, via which the fluid is recooled so to prevent higher temperature variations of the fed fluid. This is thus an indirect regulation which is relatively inert.

JP 11-303 651 A describes a fluid feed system having a conditioning device where, at the delivery line, a heater is arranged which is adapted to be bypassed via a bypass line. A regulating valve is arranged in the bypass line to regulate the respective volume flows fed to the engine via the bypass line and to the delivery line. For regulating purposes, a temperature regulator is additionally respectively arranged in the delivery line in front of and behind the branches of the delivery line and the bypass line so that the regulating valve can be regulated as a function of the desired temperatures. A reduced dynamics here too results since a flow always passes through the heater when the regulating valve is adjusted. The flow passing through the heater always changes with the flow passing through the regulating valve, which makes the regulation considerably more difficult.

It is thus problematic that a sufficiently constant target temperature which is suitable for a fluid consumption measuring system cannot be provided, in particular not sufficiently quickly provided, via conventional conditioning devices.

### SUMMARY

an aspect of the present invention is to provide a highly dynamic and accurate temperature regulation so that, in a fluid consumption measuring system, it is always possible to take measurements with an exact preset target temperature even in intermittent/nonsteady states and thus avoid errors due to density changes during the measurement. A further aspect of the present invention is that the regulation be as simple as possible.

In an embodiment, the present invention provides a conditioning device for regulating a gaseous fluid or a liquid fluid to a constant target temperature. The conditioning device includes an inlet which is fluidically connected to a supply system, an outlet which is fluidically connected to a consumer, a first fluid line which is arranged between the inlet and the outlet, a heater which is arranged in the first fluid line, a second fluid line which is arranged to branch off from the first fluid line upstream of the heater and to open out into the first fluid line downstream of the heater, a regulating valve which is arranged either in the first fluid line or in the second fluid line, the regulating valve being configured to regulate a fluid flow, a first temperature sensor which is arranged in the first fluid line downstream of where the second fluid line opens out into the first fluid line, and a check valve which is arranged either in the first fluid line or in the second fluid line in which the regulating valve is not arranged.

### BRIEF DESCRIPTION OF THE DRAWINGS

The present invention is described in greater detail below on the basis of embodiments and of the drawings in which:

FIG. 1 schematically shows a first embodiment of the setup of a conditioning device according to the present invention; and

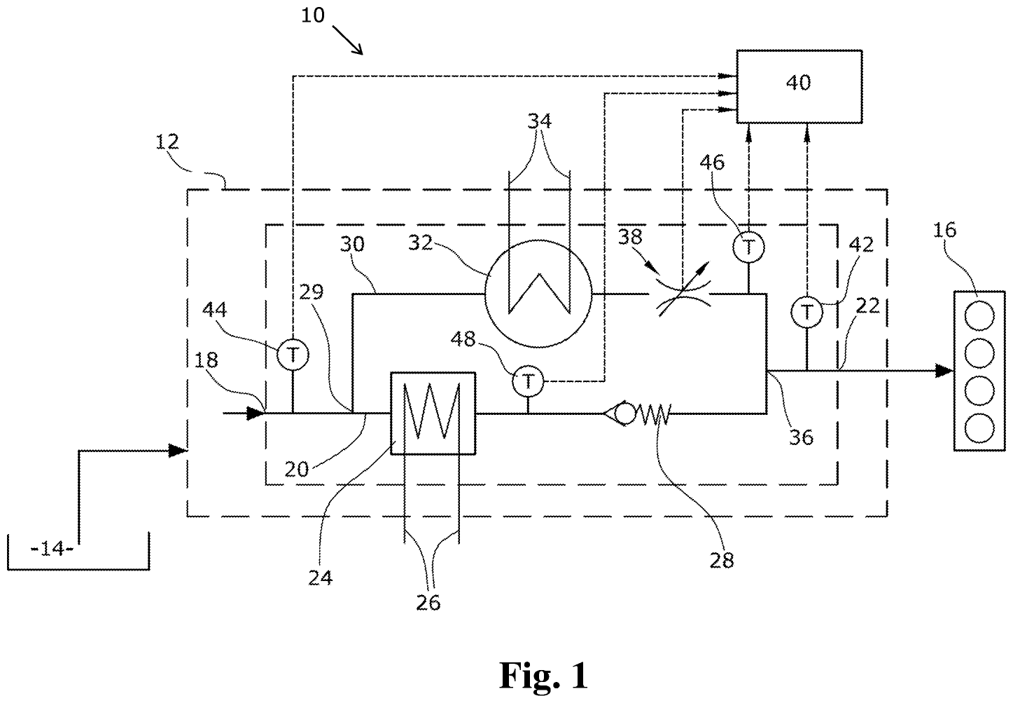

FIG. 2 schematically shows a second embodiment of the setup of a conditioning device according to the present invention.

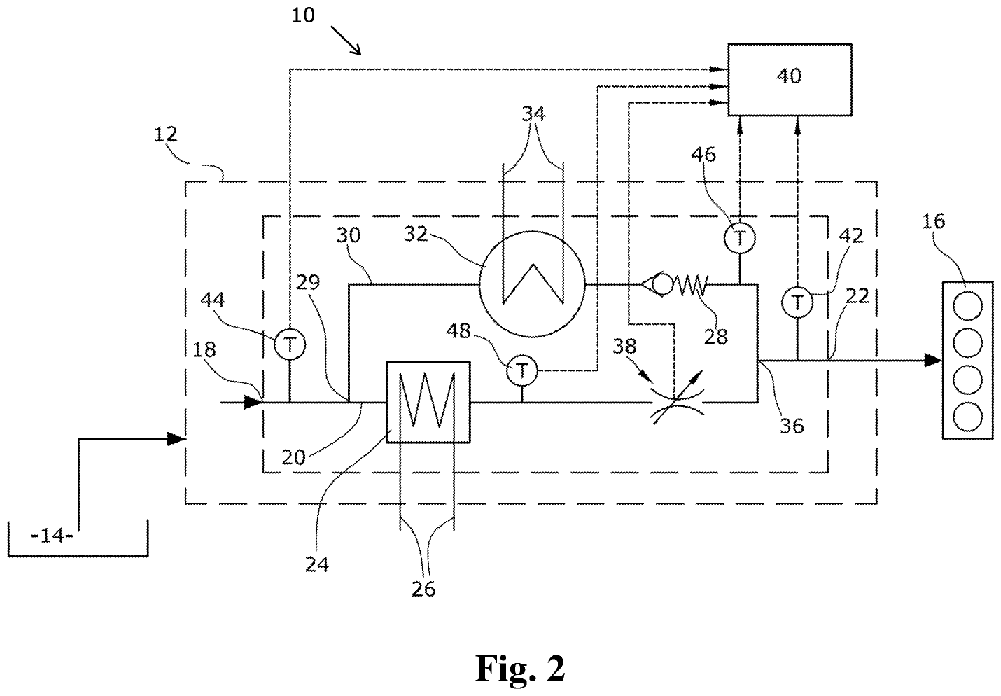

### DETAILED DESCRIPTION

Due to the fact that in the fluid line, via which the regulating valve can be bypassed, a check valve is arranged, the dynamics of the conditioning device is considerably increased since both parallel line sections can be completely cut off and thus a quick temperature change can be achieved since no mixed flow occurs. A regulating member must additionally only be controlled so that the regulation unit to be provided can be simply and inexpensively constructed. The term “parallel” as used herein merely means that both line sections comprise a common inlet and a common outlet, and that a flow thus passes through them in the same direction. A geometric parallelism is self-evidently not required.

A cooler can, for example, be arranged in the second fluid line. The additional use of a cooler together with the heater further increases the temperature gradient and thus the potential dynamics of the conditioning device.

The fluid within the framework of the present invention is to be understood as a gaseous or liquid medium, in particular a gaseous or liquid fuel or a combustible. The fluid can, however, be any other gas or any other liquid, for example, a cathode feed air fed to a cathode of a fuel cell stack of a fuel cell system; this is in particular ambient air. A supply system within the framework of the present invention is a tank, a bottle, for example, a gas bottle or a supply or feed line. The consumer is in particular an internal combustion engine or a fuel cell and/or a fuel cell stack.

It is particularly advantageous when the check vale and the regulating valve are arranged downstream of the heater and the cooler, respectively. The check valve can in particular be arranged in the first fluid line downstream of the heater, and the regulating valve can be arranged in the second fluid line downstream of the cooler. This results in a low power consumption when the regulating valve is configured as a normally closed valve since most operating states require the fluid to be heated. In this embodiment, the fluid in the respective closed line is subjected to a strong cooling and heating, respectively, which results in a quick effect during switchover.

In an embodiment of the present invention, the regulating valve can, for example, be a valve which is driven by electromagnetic or electromotive forces. This allows for a particularly quick and accurate regulation, thereby increasing the dynamics of the system.

The regulating valve can alternatively be pneumatically driven or controlled.

In an embodiment of the present invention, the regulating valve can, for example, be a proportional valve. This facilitates regulation since the fed current is directly proportional to the movement of the armature.

In an embodiment of the present invention, the heater can, for example, comprise at least one Peltier element or is configured as a Peltier element. This allows for a very accurate and quick temperature regulation of the heater so that an indirect regulation can additionally be performed.

It is further advantageous when the cooler is configured as a heat exchanger with a liquid coolant. The liquid coolant can, for example, be withdrawn from the cooling circuit of the internal combustion engine so that no additional cooling is required. The coolant can, for example, be a liquid coolant or water.

In an embodiment of the present invention, the closing force of the check valve can, for example, be designed so that the check valve is open when the regulating valve is closed, and closed when the regulating valve is open. Mixed flows can thus be produced in a simple manner and both line sections can be reliably completely cut off.

In an embodiment of the present invention, a second temperature sensor can, for example, be arranged upstream of where the second fluid line branches off the first fluid line. The sensor thus measures the temperature of the fluid flowing into the conditioning device so that, besides the absolute temperature at the outlet, the temperature difference to be overcome can be used for regulation purposes. The dynamics can hence additionally be increased.

It is additionally advantageous when, in the first fluid line, downstream of the heater and upstream of the mouth of the second fluid line, a third temperature sensor is arranged, and in particular when the third temperature sensor is arranged upstream of the check valve or the regulating valve in the first fluid line. This further improves the temperature regulation since the temperature prevailing at the check valve can also be used at any time for temperature regulation, i.e., the adjustment of the regulating valve. By storing a characteristic map in which all three temperature sensors with their values are taken into account, a very accurate position regulation of the regulating valve can hence be performed for exactly attaining the desired target temperature.

Another increase in dynamics can be attained by regulating the heating medium fed into a heating line of the heater so that the heating line heats the fluid to a differently large extent. Feeding of a heating medium is here to be understood as both feeding of current when an electric heater is used and feeding of a liquid or gaseous heating medium.

The same advantages can be achieved in the cold line section by regulating a feeding of the coolant to a coolant line of the cooler.

A conditioning device for regulating a gaseous or a liquid fluid to a constant target temperature is thus provided where, with a simple structure and a simple regulation, high dynamics can be attained even at intermittent/nonsteady states. The measured values of the fluid consumption measuring system are considerably improved in this manner.

An exemplary embodiment of a conditioning device according to the present invention for regulating a gaseous or liquid fluid to a constant target temperature is illustrated in the drawings and will be described below.

The conditioning device 10 according to the present invention is part of a fluid consumption measuring system 12 which extracts fluid via a supply system 14 and delivers it to a consumer 16 via the conditioning device 10.

The conditioning device 10 receives a fluid via an inlet 18 of a first fluid line 20. The fluid flow leaves the conditioning device 10 via an outlet 22 of the first fluid line 20 and flows to the consumer 16 to which a fluid flow with a constant target temperature is fed via the conditioning device 10 for providing a constant density, whereby errors in the conversion of measured volume flows into mass flows are avoided.

A heater 24 is arranged in the first fluid line 20, the heater 24 in particular being configured as a Peltier element or as a heater having one or a plurality of Peltier elements. The cooling performance of the Peltier element can be increased in a conventional manner when the current feed to the Peltier element via current lines serving as heating lines 26 is increased. A check valve 28 is arranged in the first fluid line 20 downstream of the heater 24. The check valve 28 is closed towards the inlet 18 and, at a sufficient pressure, is opened towards the outlet 22.

A second fluid line 30 branches off the first fluid line 20 at a branch 29 upstream of the heater 24 and again opens out into in the first fluid line 20 downstream of the check valve 28 so that the heater 24 is adapted to be bypassed via the second fluid line 30. A cooler 32 which is configured as a heat exchanger is arranged in the second fluid line 30. The cooler 32 is supplied with a liquid coolant via coolant lines 34 for extracting heat from the fluid.

Downstream of the cooler 32, a regulating valve 38 is arranged in the second fluid line 30 in front of the place 36 where the second fluid line 30 opens out into the first fluid line 20, which regulating valve 38 is in particular configured as an electromagnetic proportional valve and is controlled via a control unit 40. The regulation of the regulating valve 38 thus allows for both completely cutting off a respective one of the two fluid flows in the first fluid line 10 or in the second fluid line 30, or producing a mixed flow through the first fluid line 10 and the second fluid line 30, whereby a specific temperature of the fluid flow can be adjusted.

For the regulation to a preset target temperature, a first temperature sensor 42 is arranged in the first fluid line 20 behind the place 36 where the second fluid line 30 opens out into the first fluid line 20, via which first temperature sensor 42 the temperature at the outlet 22 of the conditioning device 10, and hence the inlet temperature into the consumer 16, can be measured. This first temperature sensor 42 is also connected to the control unit 40 so that the regulating valve 38 can be opened or closed as a function of the measured values of the first temperature sensor 42.

Optionally, for improving the regulation, a second temperature sensor 44 can be arranged in the first fluid line 20 in front of the branch 29 and a third temperature sensor 46 can be arranged in the second fluid line 30 downstream of the regulating valve 38 so that the temperatures at the outlet of the regulating valve 38 and at the inlet 18 into the conditioning device 10 can also be taken into account for regulation. The second temperature sensor 44 and the third temperature sensor 46 are also connected to the control unit 40 therefor. The second temperature sensor 44 and the third temperature sensor 46 are in particular useful when the cooler 32 and the heater 24 are adapted to be regulated in terms of their heating and cooling performance via the coolant lines 34 and the heating lines 26, respectively. When only the first temperature sensor 42 is used for regulation purposes, the cooler 32 and the heater 24 should if possible be operated at maximum power.

If a target temperature of the fluid of 60° C. is, for example, preset, but the temperature at the first temperature sensor 42 only amounts to 50° C., the fluid must be heated. The regulating valve 38 is then closed so that the second fluid line 30 is closed and the check valve 28, which is to be designed so that is completely open when the regulating valve 38 is closed and is completely closed when the regulating valve 38 is completely open, is opened so that fluid, in a heated condition, flows to the consumer 16 via the first fluid line 20 and thus via the heater 24.

The temperature difference between the actual temperature and the target temperature thereby constantly decreases. In the case of small temperature differences, a mixed flow is adjusted via the regulating valve so that the fluid flow via the first fluid line 20 is somewhat larger than that via the second fluid line 30, whereby the produced mixed flow is merely heated further to a small extent.

At too high fluid temperatures, the regulating valve 38 is thus opened so that the fluid flows to the consumer 16 via the second fluid line 30. When the regulating valve 38 is completely open, the pressure for opening the check valve 28 is not high enough so that the check valve 28 is closed. In the case of small temperature differences, the regulating valve 38 is again closed to a small extent so that the fluid flow across the cooler 32 is reduced but is still larger than the fluid flow produced in the first fluid line 20 by slightly opening the check valve 28 due to the increasing pressure across the heater 24 so that all in all the mixed flow arriving at the outlet 22 is cooled to a small extent.

In the case of very high expected temperature differences, for increasing dynamics, either the cooler 32 can be additionally supplied with a coolant or current can be additionally fed to the heater so that even larger temperature differences can be compensated for. This can be realized as a function of the measured values of the second temperature sensor 44 and the third temperature sensor 46.

The conditioning device 10 can accordingly provide a heated or a cooled fluid flow to the consumer 16 merely via a regulating member which is configured as a regulating valve, wherein a direct heating and a direct cooling of the fluid is provided. The regulation of the regulating valve 38 is performed as a function of the measured values of the first temperature sensor 42 and possibly the additional second temperature sensor 44 and the third temperature sensor 46. The regulation algorithm for regulating the regulating valve 38 is thus simple. This system distinguishes itself by a particularly high dynamics and allows for a regulation of the target temperature with deviations of less than 0.1° C. even at intermittent/nonsteady operating states of the consumer 16 which cause considerably larger temperature variations. Energy consumption can be reduced due to the use of the additional temperatures sensor(s) and since the performance of the cooler 32 and the heater 24 is adapted to be regulated. The conditioning device 10 of the present invention is suitable for both mobile and stationary fluid consumption measuring systems.

It is to be understood that a cooler need not be used in many cases since the fluid usually has temperatures which are too low. In this case, only the heater 24 is located in the first fluid line 20, while a fluid flow in the second fluid line 30 is neither cooled nor heated. The same regulating function can be provided when the position of the regulating valve 38 and the check valve 28 are swapped. The second temperature sensor 44 and the third temperature sensor 46 can also possibly be omitted or further regulating members can be positioned in the coolant lines or the heating lines of the cooler 32 and the heater 24, respectively.

The heater 24 can alternatively be omitted when the fluid has temperatures which are too high. Only the cooler 32 is then located in the second fluid line 30, while a fluid flow in the first fluid line 20 is neither cooled nor heated. The configurations can correspond to those described above in all other respects with the cooler being omitted.

The present invention is not limited to embodiments described herein; reference should be had to the appended claims.

What is claimed is:

1-13. (canceled)

14. A conditioning device for regulating a gaseous fluid or a liquid fluid to a constant target temperature, the conditioning device comprising:
an inlet which is fluidically connected to a supply system;
an outlet which is fluidically connected to a consumer;
a first fluid line which is arranged between the inlet and the outlet;
a heater which is arranged in the first fluid line;
a second fluid line which is arranged to branch off from the first fluid line upstream of the heater and to open out into the first fluid line downstream of the heater;
a regulating valve which is arranged either in the first fluid line or in the second fluid line, the regulating valve being configured to regulate a fluid flow;
a first temperature sensor which is arranged in the first fluid line downstream of where the second fluid line opens out into the first fluid line; and
a check valve which is arranged either in the first fluid line or in the second fluid line in which the regulating valve is not arranged.

15. The conditioning device as recited in claim 14, further comprising:
a cooler which is arranged in the second fluid line.

16. The conditioning device as recited in claim 15, wherein the cooler is configured as a heat exchanger which comprises a liquid coolant.

17. The conditioning device as recited in claim 15, wherein the check valve and the regulating valve are each arranged downstream of the heater or of the cooler, as the case might be.

18. The conditioning device as recited in claim 15, wherein,
the cooler comprises a coolant line into which a coolant supply is provided, and
the coolant supply is configured to be regulated.

19. The conditioning device as recited in claim 14, wherein,
the heater comprises a heating line into which a heat medium supply is provided, and
the heat medium supply is configured to be regulated.

20. The conditioning device as recited in claim 14, wherein the regulating valve is a valve which is configured to be driven by an electromagnetic force or by an electromotive force.

21. The conditioning device as recited in claim 20, wherein the regulating valve is a proportional valve.

22. The conditioning device as recited in claim 14, wherein the heater comprises at least one Peltier element or is configured as a Peltier element.

23. The conditioning device as recited in claim 14, wherein the check valve comprises a closing force which is configured so that the check valve is open when the regulating valve is closed and so that the check valve is closed when the regulating valve is open.

24. The conditioning device as recited in claim 14, further comprising:
a second temperature sensor which is arranged upstream of where the second fluid line branches off the first fluid line.

25. The conditioning device as recited in claim 14, further comprising:
a third temperature sensor which is arranged in the first fluid line downstream of the heater and upstream of where the second fluid line opens out into the first fluid line.

26. The conditioning device as recited in claim 14, further comprising:
a third temperature sensor which is arranged in the first fluid line upstream of the check valve or upstream of the regulating valve.
